(19) United States
(12) Patent Application Publication
(10) Pub. No.: US 2007/0039827 A1
(43) Pub. Date: Feb. 22, 2007

(54) Measuring alignment between a wafer chuck and polishing/plating receptacle

(75) Inventors: Hui Wang, Fremont, CA (US); Voha Nuch, San Jose, CA (US)

Correspondence Address: Hui "David" Wang, President;ACM RESEARCH, INC., 4378 Enterprise Street, Fremont, CA, 94538, US

(73) Assignee: ACM Reasearch, Inc., Fremont, CA (US)

(21) Appl. No.: 10/538,402

(22) PCT Filed: Dec. 9, 2003
(86) PCT No.: PCT/US03/39221

§ 371 Date: Jul. 21, 2006

(51) Int. Cl. B23H 3/00

(52) U.S. Cl. 205/81; 205/157; 205/645

(57) ABSTRACT

An apparatus for electropolishing and/or electroplating metal layers on a semiconductor wafer includes a receptacle having a plurality of section walls. The apparatus includes a wafer chuck configured to hold the semiconductor wafer and to position the semiconductor wafer within the receptacle with a surface of the semiconductor wafer adjacent to top portions of the plurality of section walls. The apparatus also includes a first plurality of sensors configured to measure alignment between the center of one of the plurality of section walls to the center of the wafer chuck, and thus the center of the semiconductor wafer.

### CROSS-REFERENCE TO RELATED APPLICATIONS

This application claims the benefit of U.S. Provisional Application No. 60/431,916, titled IN-SITU GAP MEASUREMENT IN ELECTRICAL PLATING/POLISHING ASSEMBLY, filed Dec. 9, 2002, which is incorporated here in by reference in its entirety.

### BACKGROUND

1. Field of the Invention

The present application relates generally to electropolishing and/or electroplating metal layers on semiconductor wafers, and more particularly to measuring alignment between a wafer chuck and polishing/plating receptacle.

2. Related Art

In general, semiconductor devices are manufactured or fabricated on disks of semiconducting materials called wafers or slices. More particularly, wafers are initially sliced from a silicon ingot. The wafers then undergo multiple masking, etching, and deposition processes to form the electronic circuitry of semiconductor devices.

For example, electroplating a conductive film on a wafer is disclosed in U.S. Pat. No. 6,391,166 B1, titled PLATING APPARATUS AND METHOD, filed on Jan. 15, 1999, which is incorporated herein by reference in its entirety. Electropolishing a metal layer on a wafer is disclosed in U.S. Pat. No. 6,395,152, titled METHODS AND APPARATUS FOR ELECTROPOLISHING METAL INTERCONNECTIONS ON SEMICONDUCTOR DEVICES, filed on Jul. 2, 1999, which is incorporated herein by reference in its entirety, and U.S. Pat. No. 6,440,295, titled METHOD FOR ELECTROPOLISHING METAL ON SEMICONDUCTOR DEVICES, filed on Feb. 4, 2000, which is incorporated herein by reference in its entirety. A chuck for holding a wafer is disclosed in U.S. Pat. No. 6,248,222, titled METHODS AND APPARATUS FOR HOLDING AND POSITIONING SEMICONDUCTOR WORKPIECES DURING ELECTROPOLISHING AND/OR ELECTROPLATING OF THE WORKPIECES, filed on Sep. 7, 1999, which is incorporated herein by reference in its entirety.

### SUMMARY

In one exemplary embodiment, an apparatus for electropolishing and/or electroplating metal layers on a semiconductor wafer includes a receptacle having a plurality of section walls. The apparatus includes a wafer chuck configured to hold the semiconductor wafer and to position the semiconductor wafer within the receptacle with a surface of the semiconductor wafer adjacent to top portions of the plurality of section walls. The apparatus also includes a first plurality of sensors configured to measure alignment between the center of one of the plurality of section walls to the center of the wafer chuck, and thus the center of the semiconductor wafer.

### DESCRIPTION OF DRAWING FIGURES

The present application can be best understood by reference to the following description taken in conjunction with the accompanying drawing figures, in which like parts may be referred to by like numerals:

FIG. 1A is a top view of an exemplary polishing/plating receptacle;

FIG. 1B is a side view of the exemplary polishing/plating receptacle depicted in FIG. 1A taken along line 1B-1B;

FIG. 2A is a top view of another exemplary polishing/plating receptacle; and

FIG. 2B is a side view of the exemplary polishing/plating receptacle depicted in FIG. 2A taken along line 2B-2B.

### DETAILED DESCRIPTION

The following description sets forth numerous specific configurations, parameters, and the like. It should be recognized, however, that such description is not intended as a limitation on the scope of the present invention, but is instead provided as a description of exemplary embodiments.

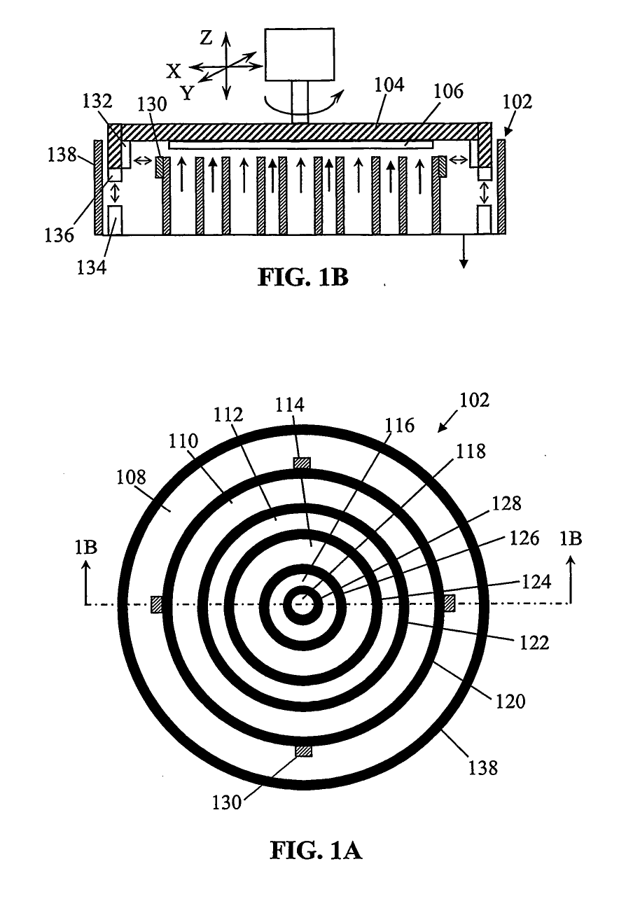

With reference to FIG. 1A, an exemplary polishing/plating receptacle 102 is depicted. In this exemplary embodiment, receptacle 102 is depicted as being divided into six sections 108, 110, 112, 114, 116, and 118 by section walls 120, 122, 124, 126, and 128. It should be recognized, however, that receptacle 102 can be divided into any number of sections by any suitable number of section walls.

As depicted in FIG. 1B, in the present exemplary embodiment, a wafer chuck 104 holds and positions a wafer 106 within receptacle 102. More particularly, wafer 106 is positioned above the tops of sections walls 120, 122, 124, 126, and 128 to form a gap of about 0.5 millimeters to about 10 millimeters, preferably 5 millimeters. The gap facilitates the flow of electrolyte between the bottom surface of wafer 106 and the tops of sections walls 120, 122, 124, 126, and 128. As also depicted in FIG. 1B, wafer chuck 104 can rotate wafer 106 within receptacle 102.

Matching/aligning the center of chuck 104, and thus the center of wafer 106, with the center of section walls 120, 122, 124, 126, and 128 is desirable/critical to achieve uniform electrolyte flow pattern, and to obtain good uniformity of metal film plated on wafer 106. More particularly, in the present exemplary embodiment, wafer 106 and section walls 120, 122, 124, 126, and 128 are cylindrical in shape. Concentrically aligning the centers of wafer 106 and section walls 120, 122, 124, 126, and 128 increases the uniformity of the metal film plated on wafer 106 or polished from wafer 106. The centers are preferably matched/aligned within a tolerance in a range of 0.001 mm to 1 mm, and preferably less than 0.01 mm.

In the present exemplary embodiment, to ensure that the centers are matched, sensors 130 and 132 are placed on section wall 120 and chuck 104, respectively, to measure the alignment. With reference to FIG. 1A, sensors 130 are disposed around the circumference of section wall 120, which lies within receptacle 102. With reference to FIG. 1B, sensors 132 are disposed around the circumference of chuck 104. As depicted in FIG. 1B, sensors 130 and 132 are paired together. Each pair of sensors 130 and 132 measures a gap between section wall 120 and chuck 104. When the gaps measured by the pairs of sensors 130 and 132 are even, then the center of chuck 104, and thus wafer 106, is aligned concentric with the center of section wall 120. As described above, in the present exemplary embodiment, the center of wafer 106 and section walls 120, 122, 124, 126, and 128 are aligned to a tolerance in a range of 0.001 mm to 1 mm, and preferably less than 0.01 mm.

The centers of chuck 104 and section wall 120 can be aligned for each wafer 106 processed in receptacle 102. Alternatively, the centers of chuck 104 and section wall 120 can be aligned after a set number of wafers 106 have been processed in receptacle 102. Additionally, the alignment of centers of chuck 104 and section wall 120 can be measured before processing and after processing a wafer 106.

The present exemplary embodiment is depicted having fours sensors 130 and 132 equally distributed in the circumference of tops of section wall 120 and chuck 104, respectively. It should be recognized, however, that any number of sensors, such as two sensors, can be used around the circumference of section wall 120 and chuck 104. It should also be recognized that sensors 130 can be disposed in various locations within receptacle 102.

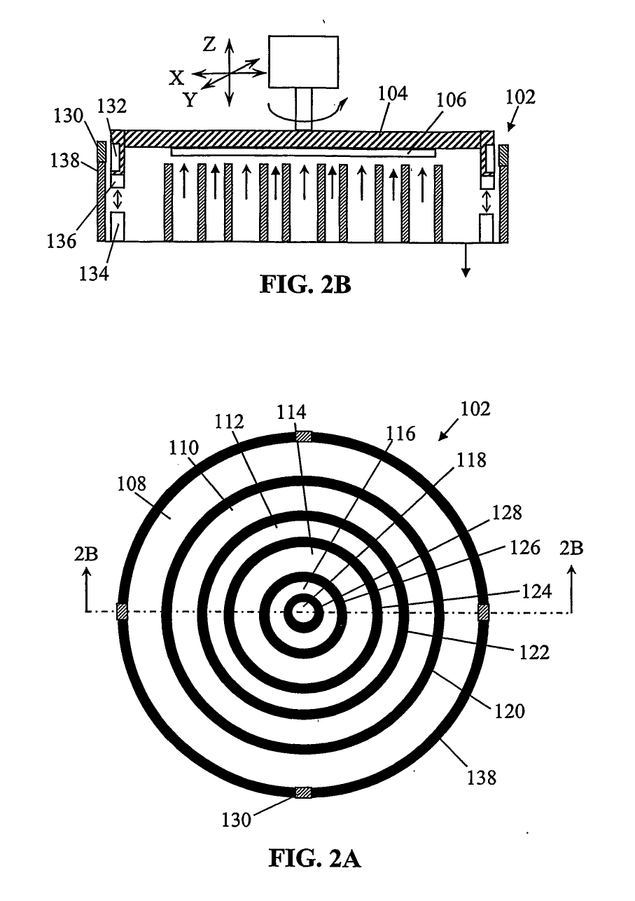

For example, with reference to FIGS. 2A and 2B, in another exemplary embodiment, sensors 130 are disposed in perimeter wall 138. Additionally, sensors 132 are disposed in an outer surface of chuck 104 rather than an inner surface of chuck 104. Thus, each pair of sensors 130 and 132 measure a gap between perimeter wall 138 and chuck 104. However, as depicted in FIG. 2B, in the present exemplary embodiment, perimeter wall 138 is cylindrical and concentric with section walls 120, 122, 124, 126, and 128. Thus, when the gaps measured by pairs of sensors 130 and 132 are even within the specified tolerance, the center of chuck 104, and thus the center of wafer 106, is aligned with the center of perimeter wall 138, and thus section walls 120, 122, 124, 126, and 128. Disposing sensors 130 in perimeter wall 138 and sensors 132 in an outer surface of chuck 104 has the advantage of shielding sensors 130 and 132 from the electrolyte, which is applied to wafer 106 during the electropolishing/electroplating process.

With reference again to FIG. 1B, sensors 130 and 132 can be optical sensors using optical reflectivity to measure the gap, or magnetic sensors, or capacitance type sensors, or ultrasonic sensors. Sensors 130 and 132 are preferably covered or shielded by coating anti-corrosive materials on the surface to prevent chemical corrosion from the electrolyte.

Similarly, to measure the gap between wafer 106 and the tops of section walls 120, 122, 124, 126, and 128, sensors 134 and 136 are placed inside the bottom of receptacle 102 and chuck 104, respectively. As depicted in FIG. 1B, sensors 134 and 136 are paired together. Each pair of sensors 134 and 136 measures a gap between bottom of receptacle 102 and chuck 104, which can be used to measure the gap between the top of section walls 120, 122, 124, 126, and 128 and wafer 106. It should also be recognized that sensors 134 can be disposed in various locations within receptacle 102, such as in perimeter wall 138. Sensors 134 and 136 can be optical sensors using optical reflectivity to measure the gap, or magnetic sensors, or capacitance type sensors, or ultrasonic sensors. Sensors 134 and 136 are preferably covered or shielded by coating anti-corrosive materials on the surface to prevent chemical corrosion from the electrolyte.

The gap between wafer 106 and the tops of section walls 120, 122, 124, 126, and 128 can be measured for each wafer 106 processed in receptacle 102. Alternatively, the gap can be measured after a set number of wafers 106 have been processed in receptacle 102. Additionally, the gap can be measured before processing and after processing a wafer 106.

With reference now to FIGS. 2A and 2B, another exemplary embodiment of polishing/plating receptacle 102 is depicted. In contrast to the exemplary embodiment depicted in FIGS. 1A and 1B, in the present exemplary embodiment, sensors 130 are disposed in receptacle 102 by being embedded into perimeter wall 138, and sensors 132 are disposed in chuck 104 by being embedded in chuck 104. As noted above, it should be recognized that sensors 130 can be disposed in various locations within receptacle 102, such as in section wall 120 (as depicted in FIGS. 1A and 1B). As also noted above, any number of sensors 130 can be used. For example, sensors 130 can be a sensor ring formed at the top of perimeter wall 138.

Although exemplary embodiments have been described, various modifications can be made without departing from the spirit and/or scope of the present invention. Therefore, the present invention should not be construed as being limited to the specific forms shown in the drawings and described above.

We claim:

1. An apparatus for electropolishing and/or electroplating metal layers on a semiconductor wafer, the apparatus comprising:
a receptacle having a plurality of section walls;
a wafer chuck configured to hold the semiconductor wafer and to position the semiconductor wafer within the receptacle with a surface of the semiconductor wafer adjacent to top portions of the plurality of section walls; and
a first plurality of sensors configured to measure alignment between a center of one of the plurality of section walls to a center of the wafer chuck.

2. The apparatus of claim 1, wherein the center of the one of the plurality of section walls is aligned with a center of the semiconductor wafer within a tolerance in a range of 0.001 mm to 1 mm.

3. The apparatus of claim 2, wherein the tolerance is less than 0.01 mm.

4. The apparatus of claim 2, wherein the plurality of section walls are cylindrical and concentric.

5. The apparatus of claim 1, wherein the first plurality of sensors includes a first sensor pair comprising:
a first sensor disposed on one of the plurality of section walls; and
a second sensor disposed on a circumference of the wafer chuck.

6. The apparatus of claim 5, wherein the first sensor is embedded in one of the plurality of section walls.

7. The apparatus of claim 1, wherein the first plurality of sensors includes a first sensor pair comprising:
a first sensor disposed on a perimeter wall of the receptacle; and
a second sensor disposed on a circumference of the wafer chuck.

8. The apparatus of claim 7, wherein the first sensor is embedded in the perimeter wall.

9. The apparatus of claim 8, wherein the first sensor is a sensor ring formed on a top portion of the perimeter wall.

10. The apparatus of claim 7, wherein the second sensor is embedded in the wafer chuck.

11. The apparatus of claim 1, wherein the first plurality of sensors includes:
a first sensor pair configured to provide a first measurement of a gap between the wafer chuck and one of the plurality of section walls; and
a second sensor pair configured to provide a second measurement of a gap between the wafer chuck and one of the plurality of section walls.

12. The apparatus of claim 1, wherein the first plurality of sensors includes:
a first sensor pair configured to provide a first measurement of a gap between the wafer chuck and a perimeter wall of the receptacle; and
a second sensor pair configured to provide a second measurement of a gap between the wafer chuck and the perimeter wall of the receptacle.

13. The apparatus of claim 1, wherein the first plurality of sensors includes:
four sensors equally distributed in a circumference of the top portion of one of the plurality of section walls; and
four sensors equally distributed in a circumference of the wafer chuck.

14. The apparatus of claim 1, wherein the first plurality of sensors includes optical reflectivity sensors, magnetic sensors, capacitance sensors, or ultrasonic sensors.

15. The apparatus of claim 1, further comprising:
a second plurality of sensors configured to measure a gap between the semiconductor wafer and the top portions of the plurality of section walls.

16. The apparatus of claim 15, wherein the gap between the semiconductor wafer and the top portion of the plurality of section walls is between a range of 0.5 millimeters to 10 millimeters.

17. The apparatus of claim 16, wherein the gap is 5 millimeters.

18. The apparatus of claim 15, wherein the second plurality of sensors includes:
a first sensor disposed inside a bottom of the receptacle; and
a second sensor disposed on the wafer chuck.

19. The apparatus of claim 15, wherein the second plurality of sensors includes optical reflectivity sensors, magnetic sensors, capacitance sensors, or ultrasonic sensors.

20. An apparatus for electropolishing and/or electroplating metal layers on a semiconductor wafer, the apparatus comprising:
a receptacle divided into a plurality of concentric sections with a center;
a wafer chuck configured to hold the semiconductor wafer and to position the semiconductor wafer within the receptacle; and
a first plurality of sensors configured to measure alignment between the center of the concentric sections and a center of the semiconductor wafer.

21. The apparatus of claim 20, wherein the concentric sections are formed by a plurality of cylindrical and concentric section walls, and wherein a surface of the semiconductor wafer to be electropolished or electroplated is positioned adjacent to top portions of the plurality of section walls.

22. The apparatus of claim 21, wherein the first plurality of sensors includes a first sensor pair comprising:
a first sensor disposed on one of the plurality of section walls; and
a second sensor disposed on a circumference of the wafer chuck.

23. The apparatus of claim 21, wherein the first plurality of sensors includes:
a first sensor pair configured to provide a first measurement of a gap between the wafer chuck and one of the plurality of section walls; and
a second sensor pair configured to provide a second measurement of a gap between the wafer chuck and one of the plurality of section walls.

24. The apparatus of claim 21, further comprising:
a second plurality of sensors configured to measure a gap between the semiconductor wafer and the top portions of the plurality of section walls.

25. The apparatus of claim 24, wherein the second plurality of sensors includes:
a first sensor disposed inside a bottom of the receptacle; and
a second sensor disposed on the wafer chuck.

26. The apparatus of claim 20, wherein the first plurality of sensors includes a first sensor pair comprising:
a first sensor disposed on a perimeter wall of the receptacle; and
a second sensor disposed on a circumference of the wafer chuck.

27. The apparatus of claim 20, wherein the first plurality of sensors includes:
a first sensor pair configured to provide a first measurement of a gap between the wafer chuck and a perimeter wall of the receptacle; and
a second sensor pair configured to provide a second measurement of a gap between the wafer chuck and the perimeter wall of the receptacle.

28. A method of electropolishing and/or electroplating metal layers on a semiconductor wafer, the method comprising:
positioning a wafer chuck holding a semiconductor wafer within a receptacle having a plurality of section walls, wherein a surface of the semiconductor wafer to be electropolished or electroplated is positioned adjacent to top portions of the plurality of section walls; and
measuring alignment between a center of one of the plurality of section walls to a center of the wafer chuck using a first plurality of sensors.

29. The method of claim 28, wherein the first plurality of sensors includes a first sensor pair and a second sensor pair, and wherein measuring alignment comprises:
measuring a first gap between the wafer chuck and one of the plurality of section walls using the first sensor pair;
measuring a second gap between the wafer chuck and one of the plurality of section walls using the second sensor pair; and
determining alignment of the wafer chuck and one of the plurality of section walls based on the measurement of the first gap and second gap.

30. The method of claim 29, wherein the first sensor pair includes:
a first sensor disposed on one of the plurality of section walls; and
a second sensor disposed on a circumference of the wafer chuck.

31. The method of claim 28, wherein the first plurality of sensors includes a first sensor pair and a second sensor pair, wherein measuring alignment comprises:
measuring a first gap between the wafer chuck and a perimeter wall of the receptacle using the first sensor pair;
measuring a second gap between the wafer chuck and the perimeter wall using the second sensor pair; and
determining alignment of the wafer chuck and the perimeter wall based on the measurement of the first gap and second gap.

32. The method of claim 31, wherein the first sensor pair includes:
a first sensor disposed on the perimeter wall; and
a second sensor disposed on a circumference of the wafer chuck.

33. The method of claim 28, further comprising:
measuring a gap between the surface of the semiconductor wafer and the top portions of the plurality of section walls using a second plurality of sensors.
